(19) United States
(12) Patent Application Publication
(10) Pub. No.: US 2005/0098180 A1
(43) Pub. Date: May 12, 2005

(54) Three-dimensional structure mask

(76) Inventors: Jung-Shen Lien, Sansia Township (TW); Po Hsiung Huang, Taipei City (TW); Hung-En Chen, Taipei (TW); Jen-Hsiung Lee, Banciao City (TW); Jing-Tzu Lin, Taoyuan County (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/808,529

(22) Filed: Mar. 25, 2004

(30) Foreign Application Priority Data
Nov. 11, 2003 (TW) 92131598

(51) Int. Cl. A62B 18/02

(52) U.S. Cl. 128/205.25

(57) ABSTRACT

A mask with a three-dimensional structure provides a one-piece structure with an upper portion, the middle portion, and a lower portion. A molded notch is located at both nasal bridge of the upper portion and chin of the lower portion. The upper portion and lower portion are reversely folded so as to form a pleat for supporting the middle portion as a three-dimensional structure mask. The three-dimensional structure mask meets the facial configuration design for accommodating to different facial shapes. Furthermore, the mask with a three-dimensional structure has a normal range of elasticity to conform to certain facial contours, therefore, decreases leakage occurrence, and increases filtration rate in a high pollution environment. More, the upper portion and the lower portion of the mask are folded in a reverse direction for avoiding a contacting pollution from touching the inner surface.

### BACKGROUND OF THE INVENTION

1. Field of the Invention

The present invention relates to a mask with a three-dimensional structure. More particularly, it is a mask providing a one-piece structure with an upper portion, a middle portion, and a lower portion. The upper portion and the lower portion are reversely folded so as to form a pleat for supporting the middle portion as a three-dimensional structure mask. The three-dimensional structure mask meets the facial configuration design for accommodating to different facial shapes. Furthermore, it has a maximum breathing clearance with a high protection. Besides, the mask is a covered type with a plane-folded design structure, which can enhance a producing speed, and decrease the material waste and the manufacturing cost.

2. Description of the Related Art

According to previous technique in the mask field, the mask is normally defined as a plane type mask and a half-facial mask. Also, the mask can be defined as a particular filter mask and a gas filter mask regarding to the application definition. The later one needs multiple-pore absorption material added in, such as activated carbon. The property of the absorption material can absorb different kinds of toxicant and organic gas. However, the mask is like a helmet, it needs a correct way to use it for achieving efficiency. Therefore, choosing or using mask not only needs to care material's filtration rate, but also has to care about the engagement between the face and the mask. If it is not tightly engaged, the air will be sucked in as well as the toxicant. Please referring to FIG. 1, it is a prior art of a plane-type structure mask. As shown in the Figure, the main components include a filter body 1′, and two of the straps 2′. The filter body 1′ comprises a non-woven spun-bonded material 10′, and a nasal bridge notch 11′. Using hands to expand the filter body 1′, and the nasal bridge notch 11 only can support the periphery of the nasal bridge in the face for an effective anti-leakage protection. The periphery of the chin does not have any notch, or other soft or stiff structure supported, therefore, the leakage portion can be increased. For a half-facial mask, the main structure comprises a cup-like filter body and two head straps. The appearance of the mask is close to a facial contour. More, the head strap for fixing the mask in an adequate position can enhance facial engagement. However, using the head strap for fixing the mask will cause stressful uncomfort in the head skull after wearing for a long period. In addition, the wearers are always under an unsmooth breathing condition while a cup-like mask covering the face for a long period. Further, the convex-shaped mask easily becomes collapse and distortion under over-force, and those lead to mask damages.

In order to overcome the above problems, it should be provided a three-dimensional structure mask. It not only improves the shortage of over-leakage in a plane-type mask, but also can reduce the stressful uncomfort in a half-facial type mask. The users and the inventers are expecting a new invention for overcoming the above problems for a long time. The inventor based on his/her practical experiments in research, design, and sales invent a three-dimensional structure mask for overcoming the above problems.

### SUMMARY OF THE INVENTION

It is an object of the present invention to provide a three-dimensional structure mask which uses a one-piece structure with an upper portion, a middle portion, and a lower portion. Therefore, the manufacture does not require a seaming process thereto decrease the material waste and manufacturing cost.

It is another object of the present invention to provide a three-dimensional structure mask, which a nasal bridge notch is located at an adequate place of the upper portion and the chin notch is located at an adequate place of the lower portion. The upper portion and lower portion are reversely folded so as to form a pleat for supporting the middle portion as a polyhedron structure design. The three-dimensional structure mask meets the facial configuration design for accommodating to different facial shapes. Furthermore, the present invention has a normal range of elasticity to conform to certain facial contours, therefore, decreases leakage occurrence, and increases filtration efficiency in a high pollution environment.

It is yet another object of the present invention to provide a three-dimensional structure mask which avoids a contacting pollution from touching the inner surface using the upper and the lower portions of the mask folded in a reverse direction.

It is yet another object of the present invention to provide a three-dimensional structure mask with two straps. The strap includes a thread type, a belt type, and a plane type, and can be an ear-hang type, a head type, or a jointed type. This, therefore, can efficiently decrease wearer's stressful uncomfort, and further to enhance the product's variety for becoming more competitive.

In order to achieve the above purposes and advantages, the present invention discloses a one-piece structure of a three-dimensional structure mask which comprises an upper portion, a middle portion, and a lower portion. A nasal bridge notch is located at an adequate place of the upper portion, and a chin notch is located at an adequate place of the lower portion. The upper portion and the lower portion are reversely folded as a three-dimensional structure mask. The three-dimensional mask meets the facial configuration design for accommodating with a high protection. Furthermore, it can enhance a breathing clearance, reduce leakage rate, increase filtration efficiency, and further use it in a high pollution environment. In addition, the upper portion and the lower portion of the mask are folded in a reverse direction for avoiding a contacting pollution from touching the inner surface. By using variety of traps, it makes the three-dimensional structural mask various.

### BRIEF DESCRIPTION OF THE DRAWINGS

The accompanying drawing is included to provide a further understanding of the invention, and is incorporated in and constitutes a part of this specification. The drawing illustrates an embodiment of the invention and, together with the description, serves to explain the principles of the invention. In the drawing,

FIG. 1 is a plane-type structure mask as a prior art;

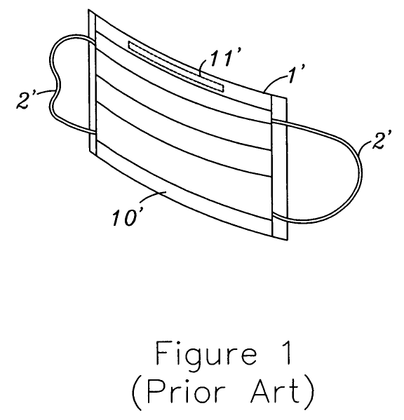

FIG. 2 is one of the preferred embodiments of the present invention showing a three-dimensional structure mask;

FIG. 3 is a back view of one preferred embodiment according to the present invention showing a three-dimensional structure mask;

FIG. 3A is an AA cross-sectional view of one preferred embodiment according to the present invention;

FIG. 4 is another preferred embodiment of the present invention showing the condition of wearing a three-dimensional structure mask;

FIG. 5 is one of the preferred embodiments of the present invention showing the middle notch; and

FIG. 5A is another preferred embodiment of the present invention showing the middle notch.

### DETAILED DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

The invention relates to a three-dimensional structure mask, which comprises with an upper portion, a middle portion, and a lower portion. Also, it uses a covered type with a plane-folded design structure to alternate a seaming process between a top rim and a bottom rim of the mask, or a stick process between a top mask body and a bottom mask body as used as a prior art. Therefore, the present invention can enhance a producing efficiency, and decrease the material waste and manufacturing cost.

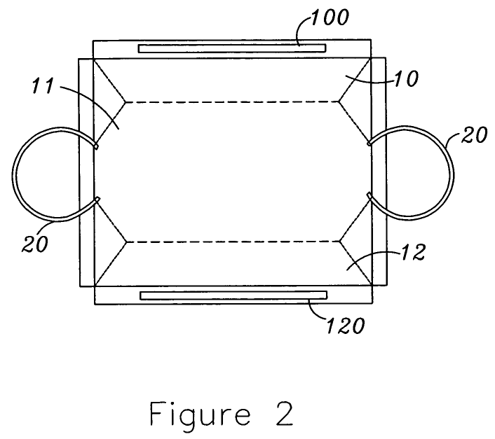

First, referring to FIG. 2, this is one of the preferred embodiments of the present invention showing a three-dimensional structure mask.

The present invention is a three-dimensional structure mask, comprising; an upper portion 10, a middle portion 11, and a lower portion 12. The upper portion 10 is located at the upper side of the middle portion 11. The middle portion 11 is located at the upper side of the lower portion 12. The upper portion, the middle portion, and the lower portion are formed as a one-piece structure. Therefore, it does not require a seaming process between a top rim and a bottom rim of the mask, or a stick step between a top mask body and a bottom mask body.

In addition, the upper portion 10 comprises a nasal bridge notch 100. The nasal bridge notch 100 is located at the upper side of the upper portion 10. Two traps 20 can be added in the middle portion 11. The trap includes a thread type, a belt type, and a plane type, and can be an ear-hang type, a head type, or a jointed type, which is linked in the both side of the middle portion 11. The lower portion 12 comprises a chin notch 120, and the chin notch 120 is located at the lower side of the lower portion 12.

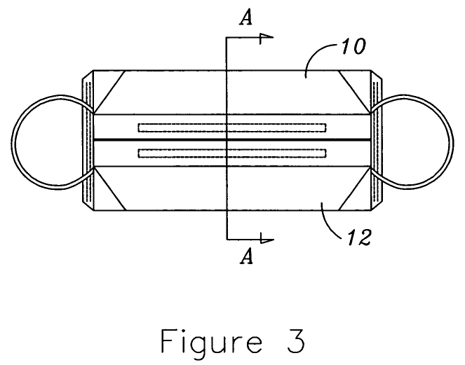

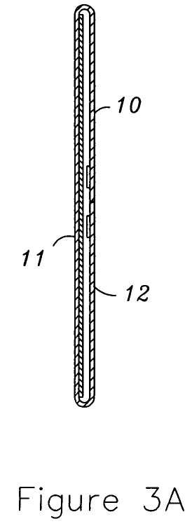

Referring to FIG. 3 and FIG. 3A, it is one of the preferred embodiments showing a back view and an AA cross-sectional view of a three-dimensional structure mask according to the present invention.

The upper portion 10 and the lower portion 12 are cut as four-beveled edges for presenting a cone-type in the two sides of the upper and the lower portions. Besides, they are folded in a reverse direction to the middle portion 11 for forming a covered plane-type design. The optimum width size of the upper portion and the lower portion is equal to half of the width size of the middle portion 11.

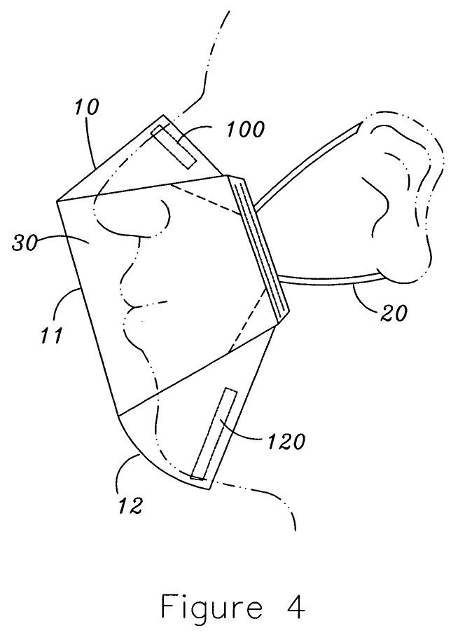

Referring to FIG. 4, it is another preferred embodiment of the present invention showing the condition of wearing a three-dimensional structure mask.

The upper portion, the middle portion, the lower portion are formed as a one-piece structure. The upper portion 10 and the lower portion 12 are cut as a four-beveled edge as well as the two sides of the upper and the lower portions presenting as a cone-shape. The three-dimensional structure mask is folded in a reverse direction to the middle portion 11. Therefore, the upper portion 10 and the lower portion 12 extend to support the middle portion 11 for a polyhedron structure. After extension, the upper bridge notch 100 of the upper portion 10 tightly engages with two sides of the nasal bridge, and the distance between two sides of the nasal bridge and the middle portion 11 increases. After extension, the chin notch 120 of the lower portion 12 tightly engages with two sides of the chin, and the distance between the two sides of the chin and the middle portion 11 increases. In this polyhedron structure design, the space between the middle portion 11 and the face increase when the middle portion extends to have higher breathing clearance and filtration rate. More, it enhances breathing smooth, and effectively reduces mask movement once face has a motion. Further, the two traps 20 can be an ear-hang type, a head type, or a jointed type.

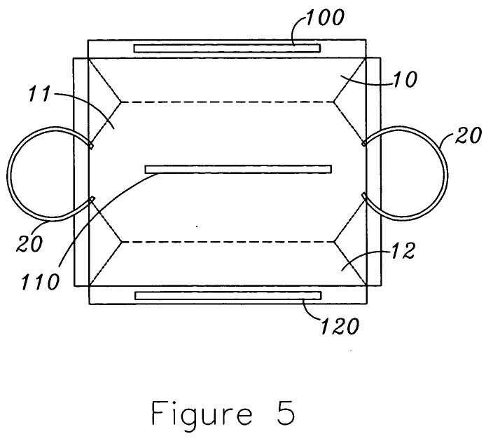

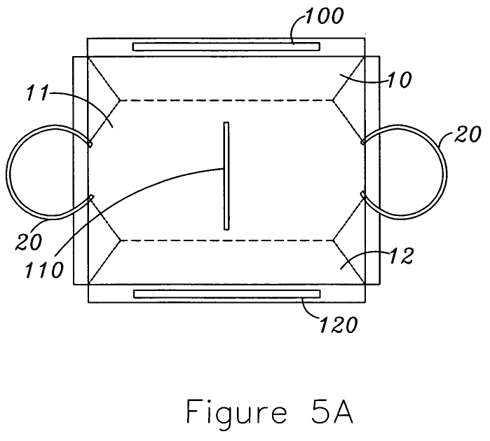

Finally, referring to FIG. 5 and FIG. 5A, they are two preferred embodiments of the present invention showing a middle notch. As shown in the figures, the three-dimensional structure mask of the present invention uses different kinds of materials for accommodating different situations. In other words, because the present invention is a three-dimensional structure mask, the middle portion 11 further includes a middle notch 110. Besides, the middle notch is located at an adequate place of the middle portion 11. As shown in the figures, they are a description showing placing outside. The middle notch can be placed in either a horizontal direction or a vertical direction. Referring to FIG. 5A, the purpose is to support the weight of the middle portion 11. Further, the mask will not become flat-shaped caused by various weights of the filtering materials. More, the shape of the middle portion 11 is various by wearer's needs and customs.

From the above description, the present invention relates to a three-dimensional structure mask with a one-piece design. It can enhance a producing efficiency, decreases material waste and manufacturing cost. Besides, the covered plane-type folded design can avoid pollution and infection by touching the inner surface. Further, a polyhedron structure design can effectively increase a breathing clearance. More, the product is various with two straps' variety. In conclusion, the present invention meets novelty, improvement, and is applicable to the industry. It therefore meets the essential elements in patentability. There is no doubt that the present invention is legal to apply to the patent, and indeed we hope that this application can be granted as a patent.

Although the present invention has been described in detail with respect to alternate embodiments, various changes and modifications may be suggested to one skilled in the art, and it should be understood that various changes, suggestions, and alternations can be made hereto without departing from the spirit and scope of the invention as defined by the appended claims.

1. A three-dimensional structure mask comprising:
an upper portion positioning in the upper place of said three-dimensional structure mask, and a nasal bridge notch being in an adequate position;
a middle portion positioning in the middle place of said three-dimensional structure mask, and positioning in the down side of said upper portion; and
a lower portion positioning in the lower place of said three-dimensional structural mask, and a nasal bridge notch being in an adequate position placing in the down side of said middle portion;
wherein the upper portion, the middle portion, and the lower portion reform a one-piece structure.

2. The three-dimensional structure according to claim 1, wherein the middle portion is composed of fiber combiners or fiber composites.

3. The three-dimensional structure according to claim 1, wherein the upper portion and the lower portion have an optimum width size which is equal to half width of the middle portion.

4. The three-dimensional structure according to claim 1, wherein the two sides of the upper portion and the lower portion are cut as four-beveled edges, and forming a polyhedron structure by comprising with the middle portion.

5. The three-dimensional structure according to claim 1, wherein the middle portion can extend for enhancing a breathing clearance with tight seal.

6. The three-dimensional structure according to claim 1, wherein the upper portion and the lower portion of a mask are folded in a reverse direction for avoiding for avoiding a contacting pollution from touching the inner surface.

7. The three-dimensional structure according to claim 1, wherein said mask comprises with two straps.

8. The three-dimensional structure according to claim 7, wherein said strap includes a thread type, a belt type, and a plane type, and can be an ear-hang type, a head type, or a jointed type.

9. The three-dimensional structure according to claim 1, wherein a middle notch placing in an adequate position of the middle portion, and the middle notch is used to support the middle portion.

10. The three-dimensional structure according to claim 9, wherein said middle notch can be either horizontally or vertically placing in an adequate place of the middle portion.
